(19) United States
(12) Patent Application Publication
(10) Pub. No.: US 2010/0251931 A1
(43) Pub. Date: Oct. 7, 2010

(54) Process for Purifying a Pigment

(76) Inventor: Charles Rupert McIntyre, Stirlingshire (GB)

Correspondence Address: MORGAN LEWIS & BOCKIUS LLP, 1111 PENNSYLVANIA AVENUE NW, WASHINGTON, DC, 20004, US

(21) Appl. No.: 12/676,296

(22) PCT Filed: Aug. 26, 2008
(86) PCT No.: PCT/GB2008/002877

§ 371 Date: Mar. 3, 2010

(30) Foreign Application Priority Data
Sep. 4, 2007 (GB) 0717102.8

(51) Int. Cl. C09D 11/02

(52) U.S. Cl. 106/31.13; 106/400

(57) ABSTRACT

A process for purifying a pigment comprising washing the pigment with water having less than 100 ppm by weight of total dissolved solids and a microbiological contamination of less than 100 colony forming units per ml. Pigments so purified are especially suitable for use in preparing ink jet printing inks.

This invention relates to processes for purifying pigments and for making pigment inks.

There are many demanding performance requirements for pigment-based printing inks and especially pigment-based ink jet printing inks. In particular, it is desirable that pigment-based ink jet printing inks can provide prints of a high quality. Poor quality prints may contain defects, e.g. poor resolution, missing pixels, lines, bands or areas. Desirably, the print quality should be high initially (directly after the preparation of the ink) and after extended periods of ink printing and/or ink storage.

In ink jet printing inks in general the formation of any oversized or precipitated pigment material in the ink will tend to impair its firing through the tiny nozzles and thereby reduce print quality. Accordingly, it is desirable that the pigment-based ink has and can maintain good colloidal stability.

Maintaining print quality over extended printing runs tends to be more difficult for thermal ink jet printers. One reason for this is the tendency for thermal firing resistors to become contaminated with koga (burnt deposits) by a process often referred to as kogation.

Accordingly, there is a need to provide pigments which can be used to prepare inks and especially ink jet printing inks having the desirable properties mentioned above.

Biocides have been included in inks containing pigments. The inclusion of biocides can, however, result in inks which are less toxicologically acceptable. For example, some biocides are skin sensitizing and as a result the ink may require risk labelling. Many micro-organisms have developed survival counter measures against biocides. Such counter measures can include going into a dormant state, forming biofilms which resist attack and digesting or sequestering the biocide itself. In addition, micro-organisms tend to evolve and adapt to overcome the biocide effectiveness. Lastly, the pigments may tend to adsorb the biocide onto their surface. Carbon black in particular tends to adsorb organic compounds. This adsorption can leave the ink depleted in biocide which in turn increases the potential for microbiological spoilage. Additionally, biocides tend to kill micro-organisms but they don't remove micro-organisms. Thus, pigment-based inks treated with biocides can still be contaminated with large numbers of dead micro-organisms.

U.S. Pat. No. 5,281,261, Example 1, part IB, describes purification of a pigment by dispersing it in distilled water and spinning down the pigment by centrifugation at 5,500 R.P.M. for 1 hour. The supernatant containing unwanted electrolytes, unwanted monomer and impurities was then removed from the pigment by decantation. No steps were taken to avoid microbiological contamination of the distilled water or in fact any of the other components which were later used to make an ink jet ink.

U.S. Pat. No. 6,503,449, which is not in the field of ink jet printing, describes the combined use of a biocide and use of ultrasound for killing micro-organisms in water-based suspensions of solid particles. This is an energy intensive process which may tend to destabilise a proportion of the particulate solid.

We have surprisingly found that when the water used to purify a pigment has both a particularly low amount of total dissolved solids and a low number of colony forming units the resulting pigment can be used to prepare inks and especially ink jet printing inks which provide one or more of the desirable properties mentioned above.

According to a first aspect of the present invention there is provided a process for purifying a pigment comprising washing the pigment with water having less than 100 ppm by weight of total dissolved solids and a microbiological contamination of less than 100 colony forming units per ml.

The pigment may be inorganic (including organo metallic) or organic. Pigments are essentially insoluble in liquids such as water and acetone.

Preferred organic pigments include, for example any of the classes of pigments described in the Colour Index International, Third Edition, (1971) and subsequent revisions of, and supplements thereto, under the chapter headed “Pigments”.

Examples of organic pigments are those from the azo (including disazo and condensed azo), thioindigo, indanthrone, isoindanthrone, anthanthrone, anthraquinone, isodibenzanthrone, triphendioxazine, quinacridone and phthalocyanine series, especially copper phthalocyanine and its nuclear halogenated derivatives, and also lakes of acid, basic and mordant dyes. Preferred organic pigments are phthalocyanine pigments, especially copper phthalocyanine pigments, azo pigments, indanthrone, anthanthrone, quinacridone pigments.

Preferred inorganic pigments include carbon black, titanium dioxide, aluminium oxide, iron oxide and silicon dioxide.

In the case of carbon blacks these may be prepared in such a fashion that some of the carbon black surface has oxidized groups (e.g. carboxy and/or hydroxy groups). However, the amount of such groups is preferably not so high that the carbon black is dispersible in water at 20° C. without the aid of a dispersant.

Preferably the pigment is a cyan, magenta, yellow or black pigment or a mixture comprising two or more of the same.

The pigment may be a single chemical species or a mixture comprising two or more chemical species (e.g. a mixture comprising two or more different pigments). Preferably the pigment is not dispersible in water at 20° C. without the aid of a dispersant. Preferably the pigment has not been surface treated so as to have ionic groups covalently bonded to its surface (for example carboxylic acid or sulphonic acid groups).

In a preferred embodiment the pigment is encapsulated by a cross-linked dispersant (hereinafter encapsulated pigment). In this embodiment the process of the present invention does not necessarily require the step of preparing an encapsulated pigment because one may use an ‘off the shelf’ or bought-in encapsulated pigment.

Preferably, such encapsulated pigments are prepared by cross-linking a dispersant in the presence of a pigment and a liquid medium. Preferred encapsulated pigments of this type are described in PCT patent publication WO 2006/064193.

Preferably the pigment is in the form of a dispersion, more preferably the pigment is present in the form of particles dispersed in a liquid medium.

The pigment preferably has an average particle size of less than 1 micron, more preferably from 50 nm to 500 nm and especially from 50 nm to 300 nm. The average particle size is preferably measured by a light scattering technique. The average particle size is preferably a volume or z-average size.

Because pigment as supplied or as prepared may already be contaminated with micro-organisms it is preferred to sterilise the pigment. The word “sterilise” as used herein means all methods which substantially reduce the amounts of viable (living) micro-organisms present.

The pigment may be sterilised before, during and/or after the washing step.

Preferably, the pigment is sterilised before the washing step.

Preferably, pigment sterilisation is performed by heating the pigment.

Preferably, heating the pigment kills at least 90% of any microbiological contamination present on the pigment. Preferably, the heating step kills at least 99%, more preferably at least 99.9%, especially at least 99.99% of the microbiological contamination.

Encapsulated pigments are preferred because they are generally stable in aqueous media to higher temperatures than pigments which rely upon a conventional, non-crosslinked dispersant to prevent them from settling out of the dispersion. This allows higher temperatures to be used for killing any microbiological contamination than would be the case for a pigment which is not an encapsulated pigment.

The pigment is preferably heated in dry form (for example by autoclaving a pigment powder) or, more preferably, the pigment is heated in the form of liquid dispersion (especially an aqueous dispersion).

When the pigment is heat sterilised before washing the pigment is preferably heated to a temperature of at least 55° C., more preferably at least 60° C. and especially at least 70° C. The maximum heating temperature depends on the particular pigment, whether it is encapsulated and the presence and stability of any other chemicals which are present. However heating will usually be to a temperature of no more than 150° C., more preferably no more than 80° C. Preferably the pigment is heated to a temperature from 55 to 80° C. The duration of the heating is preferably at least 1 minute, more preferably from 10 minutes to 24 hours and especially from 30 minutes to 10 hours.

When the pigment is an encapsulated pigment which has been prepared by cross-linking a dispersant in the presence of the pigment and a liquid medium the cross-linking is often effected by a heating step. In such embodiments it is preferred to use the abovementioned heating temperatures and durations to effect cross-linking. Thus, the temperatures and durations preferably exceed those necessary just for the cross-linking step. In this way the cross-linking step is also in effect a sterilising step.

Many processes for purifying water do nothing to reduce the levels of microbiological contamination. For example, deionisation using deionising resins and carbon filtration do not usually remove micro-organisms. To the contrary, it is often the case that carbon filters and deionising resins become extensively colonised with micro-organisms. These colonies readily contaminate any water passing through the carbon filter or deionising resin.

The purification of water by distillation or reverse osmosis to remove dissolved salts may also inadvertently result in the freshly purified water having a lower level of microbiological contamination. However, generally the water is readily and quickly re-contaminated with micro-organisms because the pigment industry does not usually take much care to prevent micro-organisms multiplying. This can be contrasted with the pharmaceutical industry where it is crucial to prevent the re-growth of micro-organisms which could harm a compromised patient. The micro-organisms that re-contaminate the purified water may originate from contact with air or from surfaces. Micro-organisms may be living in and multiplying in the reverse osmosis or distillation apparatus. Thus, distilled water and reverse osmosis water in the context of the pigment field do not connote a level of microbiological sterility that may be understood in the pharmaceutical field.

Thus the deionised or distilled water used to wash pigments in U.S. Pat. No. 5,281,261 mentioned above is likely to have contained significant amounts of microbiological contamination.

Preferably the water used to wash the pigment has less than 50 ppm by weight, more preferably less than 25 ppm, especially less than 10 ppm and most especially less than 5 ppm by weight of total dissolved solids. Inorganic salts are often found to be dissolved in water. Common inorganic salts found in water include those containing magnesium, calcium, sodium and potassium cations with carbonate, bicarbonate, chloride, nitrate, sulphate and silicate anions.

The amount of total dissolved solids in the water used to wash the pigment is preferably established gravimetrically. A preferred method comprises filtering the water through a filter having an average pore size of 0.2 microns, weighing a sample of water (W1), evaporating all of the water from the sample, weighing any residue left behind after the evaporation (W2) and the ppm of dissolved solid is given by the calculation (W2×1,000,000)/W1. For example, if 1 litre of water is evaporated and leaves 2 mg of residue this means the water originally contained (0.002 g×1,000,000)/1000 g=total dissolved solids of 2 ppm.

The advantage of this method is that it is more accurate for very low levels of total dissolved solids than, for example, conductivity measurements. Also, this method accounts properly for the presence of neutral impurities which would not be conducting. Further, this method is not prone to artefacts originating from dissolved gases such as CO₂ which affect the conductivity of the water.

The water used in the process of the present invention is preferably substantially free from insoluble solids other than small amounts of micro-organisms. Preferably, the water used in the process of the present invention is substantially free from inorganic insoluble solids, especially inorganic silicon contain compounds.

Preferably, the total amount of insoluble solids in the water (micro-organisms and other materials) is less than 5 ppm by weight, more preferably less than 1 ppm by weight and especially less than 0.1 ppm by weight.

The amount of total insoluble solids can be estimated gravimetrically by filtration, for example using a filter having an average pore size of 0.2 microns.

The extent of microbiological contamination in terms of colony forming units (cfu's) per ml (i.e. per 1 cm³) can be measured by any number of techniques. For example, one conventional technique is the agar spread plate method. In this method, 1 ml of the water is spread over an agar plate, the agar plate is then incubated for 48 hours at a temperature 37° C. and the number of colonies which form on the plate is then counted. Counting can done by eye or, more commonly nowadays, by computer using a combination of image capture and image analysis. It is often advantageous to stain the colonies to improve the contrast.

All of the colonies formed are counted. No distinction is made between pathogenic and non-pathogenic micro-organisms. Fungal, bacterial and yeast colonies are counted.

Easy-to-use, hand-held HPC Samplers for measuring the number of cfu's per mil of water are commercially available from Millipore. HPC Samplers use an American Society for Testing and Materials (ASTM) recognized method for the detection of bacteria in water. The ASTM used is the Standard Test Method for On-Site Screening of Heterotrophic Bacteria in Water, Designation F 488-95, which is described in the Annual Book of ASTM Standards Vol. 11.02 Water (II), pp 1013-1017, available from ASTM, West Conshohocken, Pa.).

When the number of cfu's per ml of water is low it is convenient to use larger volumes of water (for example 100 ml or 1000 ml) and to concentrate the micro-organisms on a filter. A suitable filter has an average pore size of below 1 μm, preferably from 1 μM to 0.1 μm. Preferred filters include a 0.45 μm Millipore HA filter available from Millipore and a 0.2 μm Nucleopore™ filter from Corning. The filter itself is then contacted onto an agar plate which is incubated as normal.

A particularly sensitive method for assessing the number of cfu's per ml is epifluorescence microscopy analysis. Cyanotolyl tetrazolium chloride (CTC) staining techniques are preferably used in this method. CTC is available from Polysciences. The CTC count represents the total number of micro-organisms with a potential for respiration. This can be considered to equate to the numbers of colonies which would be formed on optimal growth media. A preferred method is that described by Kawai, M., N. Yamaguchi, and M. Nasu, in 1999, titled “Rapid enumeration of physiologically active bacteria in purified water used in the pharmaceutical manufacturing process” and published in The Journal of Applied Microbiology 86:496-504.

Preferably, the water has a microbiological contamination of less than 10, more preferably less than 1, especially less than 0.1, and most especially less than 0.01 colony forming units per ml. An additional advantage of such low levels of cfu's is that a given amount of pigment can be washed with large volumes of water without the pigment picking up large numbers of micro-organisms. This allows pigments to be extremely well washed without becoming highly microbiologically contaminated. Thus highly pure pigments can be prepared which may be used to prepare inks having improved storage stability.

Water having the required level of less than 100 ppm by weight of total dissolved solids may be obtained by purifying water containing at least 100 ppm by weight of total dissolved solids Any suitable purification method may be used for achieving the desired total dissolved solids content, for example distillation, ion-exchange, reverse osmosis or a combination of two or more of these methods. We find that it is often desirable to combine these methods for example reverse osmosis followed by ion-exchange.

In some embodiments it is useful to contact the water with activated charcoal because this helps to adsorb and remove any neutral compounds initially present in the water.

Preferably the process comprises the step of purifying water by reducing its total dissolved solids content to below 100 ppm before or at the same time as reducing its microbiological contamination to less than 100 colony forming units per ml. The water so prepared may then be used to wash the pigment.

One reason for this preference is that the process for removing dissolved solids can sometimes contaminate water with micro-organisms, so performing any micro-organism sterilising step after the dissolved solids removal step makes it easier to achieve water satisfying both requirements.

Water having a microbiological contamination of less than 100 cfu's per ml may be prepared by sterilising water having a microbiological contamination of at least 100 cfu's. One sterilisation method is to use one or more biocides. For example, the water used in the process may comprise less than 100 ppm by weight of biocide to ensure the water has a microbiological contamination of less than 100 cfu's per ml.

The amount of biocide required to ensure the water has a microbiological contamination of less than 100 cfu's per ml depends to some extent on the level of microbiological contamination before the biocide is added, the particular micro-organism originally in the water and the ability of the particular biocide used to kill the relevant micro-organism. Of course, when present the amount of biocide used is relatively small and less than 100 ppm must be used. When biocide is utilised to sterilise the water preferred amounts are from 1 ppm to 99 ppm, more preferably from 50 to 99 ppm.

Suitable biocides include isothiazolones, quaternary ammonium salts, hypochlorites, guanides and biguanides, chlorine, chloramines, ozone and compounds which generate activated oxygen.

While biocides may be used to ensure the water has the required cfu count, it is preferred that no biocide is added to the water used to wash the pigment. Therefore the water used in the process in this embodiment will be free or substantially free from biocides. We say substantially free because it is still possible for trace amounts (e.g. less than 0.1 ppm by weight) of biocides to be present in town water as a result of purification processes performed at water treatment plants to render the water potable before it is piped to consumers.

Physical methods are preferred for preparing water having the required cfu count. Thus in a preferred embodiment the process comprises the step of sterilising the water by a process comprising heat treating, distilling, irradiating with electromagnetic radiation, filtering to remove micro-organisms or a combination of two or more thereof, performed such that the water following such sterilisation has a microbial contamination of less than 100 cfu's per ml. These physical methods of sterilising the water can be performed in a batch, continuous or any other fashion.

A preferred form of irradiation with electromagnetic radiation is ultra-violet light. Thus, in a preferred embodiment the process comprises the step of irradiating the water with ultraviolet light, preferably in a dose sufficient to lower the microbial contamination to less than 100 cfu's per ml.

Preferably, the process of the present invention comprises the step of filtering the water using a filter having an average pore size of no more than 1 micron, more preferably no more than 0.5 micron, especially no more than 0.2 microns and more especially no more than 0.1 micron. This filtration step may remove micro-organisms and insoluble solids other than micro-organisms (e.g. dust) to help obtain water of the quality required for the process.

The filter may have an extremely small pore size if desired, for example one may use a reverse osmosis filter (i.e. a filter with pores just sufficiently large to allow the selective passage of water molecules). Preferably the filter has a pore size of no less than 50 Daltons.

Preferred filtration methods include microfiltration, ultrafiltration, nanofiltration and especially reverse osmosis (also known as hyperfiltration).

When water is purified by steps which comprise contacting the water with a carbon filter and/or deioniser resin it is preferred that these steps are followed by a filtration step as described above, especially a reverse osmosis step as described above. The reason for this is that carbon filters and deioniser resins tend to contaminate the water with micro-organisms.

Preferred heat treatments are those where the water is heated to a temperature of at least 80° C., more preferably at least 90° C. and especially at least 95° C. Preferably the water is heated to a temperature of no more than 150° C. To achieve temperatures above 100° C. the water can be pressurized during heating. The duration of the heat treatment is preferably at least 10 seconds, more preferably from 10 seconds to 8 hours and especially from 30 seconds to 1 hour.

Particularly preferred physical methods for sterilising the water comprise distillation and/or reverse osmosis.

It is preferred that impurities are removed from the water by a process comprising the following steps in the order I) followed by II):

I) contacting the water with activated charcoal; and

II) reverse-osmosis treatment of the water.

By tailoring the particular conditions used these methods advantageously may be performed in such a manner as to provide water having less than 100 ppm by weight of total dissolved solids and a microbiological contamination of less than 100 colony forming units per ml.

A particularly preferred process according to the first aspect of the present invention comprises the steps:
(a) purifying water having at least 100 ppm by weight of total dissolved solids and/or a microbiological contamination of at least 100 colony forming units per ml whereby water is produced having less than 100 ppm by weight of total dissolved solids and a microbiological contamination of less than 100 colony forming units per ml; and
(b) washing a pigment with water resulting from step (a).

The steps I) and II) may be performed simultaneously or in any order, however they are preferably performed in the order I) and then II).

As indicated above, water tends to become microbiologically contaminated soon after it has been purified.

We have found that there are several ways of using the purified water to wash the pigment whilst it still has the required low levels of microbiological contamination.

In one approach the pigment is washed with water shortly after it has been purified. Preferably, within 24 hours of having been purified.

One approach is to perform step (b) within 24 hours of step (a), more preferably within 10 hours, especially within 5 hours and more especially within 1 hour of step (a). A particularly preferred embodiment is where step (b) is performed immediately after step (a).

In another approach, the process further comprises the step of shielding the water used to wash the pigment from airborne bacteria. In this way, longer times between step (a) and step (b) can be tolerated than would otherwise be the case.

The product of step (a) may be shielded from airborne bacteria in a number of ways. For example, the product of step may be stored under a blanket of bacteria free gas, for example bacteria free air or nitrogen. Also the product of step (a) may be stored in a sealed container to prevent contamination from airborne bacteria. Preferably, the shielding prevents contact of the water used to wash the pigment with airborne bacteria.

It is also preferred that step (b) is performed under conditions which shield the pigment being washed from airborne bacteria. Suitable shielding methods are as described above. Again, shielding preferably prevents contact of the water and pigment present in step (b) with airborne bacteria.

In one embodiment the product of step (a) is circulated though a UV-sterilizing unit in order to maintain sterility until such time as step (b) is performed. Preferably this circulation is performed for most or all of the time between steps (a) and (b).

In another embodiment the product of step (a) is stored at a temperature above 80° C., more preferably above 90° C., in order to maintain sterility until such time as step (b) is performed. The temperature is preferably allowed to drop to ambient or near ambient temperature shortly before step (b) is performed.

It will be appreciated that in all the methods described below that unless stated otherwise the water used to wash the pigment is as hereinbefore defined in relation to the present invention.

The pigment may be washed by any suitable method, bearing in mind the desire to avoid microbiological contamination of the resultant washed pigment. One method for washing the pigment is to mix the water and the pigment and then isolate the pigment from the water, for example by centrifugation, decantation or, more preferably by a filtration method. In a preferred embodiment the washing is performed by a process comprising retaining the pigment on a filter and passing the water through the pigment and filter. Suitable filters have a pore size which retains all or substantially all of the pigment and allows water and water-soluble materials (e.g. salts) to pass through. Preferred filters of this kind include microfiltration and ultrafiltration filters depending on the particle size of the pigment. A second and more preferred washing method comprises cross-flow filtration. In cross-flow filtration the pigment and the water are allowed to flow in the direction of the axis of a filtration membrane, for example a tubular membrane may be used and the pigment and water flow through the tube with water-soluble components passing through the tube walls along the way. This can be contrasted with conventional ‘dead end’ filtration where the mixture to be filtered flows directly towards the filter and accumulates on it. Cross-flow filtration has the advantage of a lower tendency to block the filter than ‘dead end’ filtration. If desired water which permeates through the microfilter or ultrafiltration membrane may be replaced by the additional water having less than 100 ppm by weight of total dissolved solids and a microbiological contamination of less than 100 colony forming units per ml so as to maintain fluidity and increase washing efficiency.

Preferred ultrafiltration membranes have a molecular weight cut-off (MWC) of 50,000 to 1,000,000 daltons, more preferably 100,000 to 500,000 daltons and especially 200,000 to 400,000 daltons.

The MWC value is usually specified by the manufacturer of the membrane. The MWC value may be experimentally determined by use of compounds of known molecular weight. Such compounds of known molecular weight may be proteins, saccharides or more preferably polyacryic acid polymers.

Preferably the membrane has an MWC of no more than 1,000,000 and an average pore size of no more than 0.2 microns. These conditions may greatly assists in preventing or inhibiting the pigment from blinding the membrane.

Preferred membranes are available commercially, for example from suppliers such as Alfa-Laval/DSS, Sartorious, Whatman, GE Osmonics and ITT Sanitaire.

The membrane may be in any suitable form, for example in the form of a tube or a flat sheet.

Preferably the membrane is or comprises a ceramic, polyester, fluoropolymer, polyamide or, more preferably, polyether sulfone or polysulfone layer.

The process of the present invention may optionally comprise washing the pigment with a liquid which is not as defined in the first aspect of the present invention. In this embodiment it is preferred that this water has a microbiological contamination of less than 100 colony forming units per ml but has a total dissolved solids of 100 ppm or more. In this way one may use relatively impure water to wash out impurities from the pigment and then follow with purer water as defined in the present invention. Preferably this water contains the preferred amounts of cfu's as previously described.

In view of the above, one embodiment of the present invention is a process for purifying a pigment comprising a step of washing the pigment with water having:
i) 100 ppm or more of total dissolved solids; and
ii) a microbiological contamination of less than 100 colony forming units per ml;

followed by step comprising washing the pigment with water having:
i) less than 100 ppm of total dissolved solids; and
ii) a microbiological contamination of less than 100 colony forming units per ml.

This process has the cost advantage that much of the total water used for washing the pigment need not be purified to the same extent. For example, the water used in the first washing step might be town water. Preferably, however, the water used in the first washing has been contacted with activated charcoal.

Preferably, 1 part of pigment by weight is washed with at least 5 parts of water, more preferably from 5 to 1000 parts of water and especially from 10 to 500, most especially from 20 to 100 parts by weight of water as defined in the first aspect of the present invention. The present invention allows pigments to be extensively washed and thereby well purified whilst reducing the tendency for the pigment to become contaminated with micro-organisms. These pigments can in turn be used to prepare inks which exhibit good print quality.

In a preferred embodiment the washed pigment and any remaining wash water that may still be present are sterilised. The sterilising methods are as described previously in relation to pigment sterilisation. Preferably the pigment and any remaining wash water is sterilised by heating to a temperature of 55 to 150° C., more preferably, 55 to 90° C., especially 60 to 85° C. The duration of the heating is preferably at least 10 seconds, more preferably from 10 seconds to 1 hour and especially from 30 seconds to 10 minutes. Because few viable micro-organisms are now present very mild heating conditions can be used.

In a particularly preferred embodiment the pigment is heat sterilised before the washing step and the pigment and any remaining wash water are heat sterilised after the washing step.

Purified pigments obtained or obtainable by the process of the present invention can be used in a variety of applications but they are especially useful as raw materials for preparing ink jet printing inks. A particular advantage of the pigments obtained by the processes of the present invention is that inks containing them have good storage stability. This is especially so for aqueous inks. It is also possible to reduce the amounts of the biocides present in the ink or to modify the ink formulation so as to contain less potent and more toxicologically acceptable biocides.

According to a second aspect of the present invention there is provided a process for preparing an ink comprising purifying a pigment by a process according to the first aspect of the present invention and mixing the purified pigment with one or more ink additives.

Preferably, the process according to the second aspect of the present invention is performed under mixing conditions which shield the product of the first aspect of the present invention and the one or more ink additives from airborne bacteria. Suitable prevention methods are as described above. More preferably, the process according to the second aspect of the present invention is performed under mixing conditions which prevent the purified pigment and the one or more ink additives from contacting airborne bacteria.

Preferably one or more of the ink additives have a microbiological contamination of less than 100 colony forming units per ml. More preferably all the ink additives used to prepare the ink have a microbiological contamination of less than 100 colony forming units per ml. In this way an ink results which also has a microbiological contamination of less than 100 colony forming units per ml. The amounts of colony forming units in the ink additives are preferably as hereinbefore described with respect to the water used to wash the pigment.

Preferably the process according to the second aspect of the present invention further comprises the step of shielding the resultant ink from airborne bacteria. Suitable shielding methods are as described above. More preferably, the process according to the second aspect of the present invention further comprises the step of preventing the resultant ink from contacting airborne bacteria.

Preferably the ink resulting from the process according to the second aspect of the present invention has a viscosity of less than 50 mPa·s, more preferably less than 30 mPa·s and especially less than 15 mPa·s, when measured at a temperature of 25° C.

Preferably the ink resulting from the process according to the second aspect of the present invention has a surface tension of 20 to 65 dynes/cm, more preferably 25 to 50 dynes/cm, when measured at a temperature of 25° C.

The ink additives may be of any of the additives suitable for use in inks, for example viscosity modifiers, pH buffers (e.g. 1:9 citric acid/sodium citrate) corrosion inhibitors, biocides, dyes, water, organic solvent(s) and/or kogation reducing additives. Preferably, the ink additives comprise water and at least one water-miscible organic solvent, more preferably water, at least one water-miscible organic solvent and at least one surfactant.

The ink additives which may be employed to achieve the preferred viscosity and surface tension values mentioned above include surfactants, water, organic solvent(s) and combinations of these additives.

Preferably the ink is aqueous.

Preferably, the ink prepared by the above process contains water and organic solvent in a weight ratio of from 99:1 to 1:99, more preferably from 99:1 to 50:50 and especially from 95:5 to 70:30.

Preferred organic solvents are water-miscible organic solvents. Suitable organic solvents include C₁₋₆-alkanols, preferably methanol, ethanol, n-propanol, isopropanol, n-butanol, sec-butanol, tert-butanol, n-pentanol, cyclopentanol and cyclohexanol; linear amides, preferably dimethylformamide or dimethylacetamide; ketones and ketone-alcohols, preferably acetone, methyl ether ketone, cyclohexanone and diacetone alcohol; water-miscible ethers, preferably tetrahydrofuran and dioxane; diols, preferably diols having from 2 to 12 carbon atoms, for example pentane-1,5-diol, ethylene glycol, propylene glycol, butylene glycol, pentylene glycol, hexylene glycol and thiodiglycol and oligo- and poly-alkyleneglycols, preferably diethylene glycol, triethylene glycol, polyethylene glycol and polypropylene glycol; triols, preferably glycerol and 1,2,6-hexanetriol; mono-C₁₋₄-alkyl ethers of diols, preferably mono-C₁₋₄-alkyl ethers of diols having 2 to 12 carbon atoms, especially 2-methoxyethanol, 2-(2-methoxyethoxy)ethanol, 2-(2-ethoxyethoxy)-ethanol, 2-[2-(2-methoxyethoxy)ethoxy]ethanol, 2-[2-(2-ethoxyethoxy)-ethoxy]-ethanol and ethyleneglycol monoallylether; cyclic amides, preferably 2-pyrrolidone, N-methyl-2-pyrrolidone, N-ethyl-2-pyrrolidone, caprolactam and 1,3-dimethylimidazolidone; cyclic esters, preferably caprolactone; sulphoxides, preferably dimethyl sulphoxide and sulpholane. Preferably, the liquid medium comprises water and 2 or more, especially from 2 to 8, water-miscible organic solvents.

Especially preferred water-miscible organic solvents for the ink are cyclic amides, especially 2-pyrrolidone, N-methyl-pyrrolidone and N-ethyl-pyrrolidone; diols, especially 1,5-pentane diol, ethyleneglycol, thiodiglycol, diethyleneglycol and triethyleneglycol; and mono-C₁₋₄-alkyl and di-C₁₋₄-alkyl ethers of diols, more preferably mono-C₁₋₄-alkyl ethers of diols having 2 to 12 carbon atoms, especially 2-methoxy-2-ethoxy-2-ethoxyethanol.

Preferably the ink is suitable for use in ink jet printing ink.

The pH of the ink is preferably from 4 to 11, more preferably from 7 to 10.

When the ink is used as an ink jet printing ink, the ink preferably has a concentration of halide ions of less than 500 parts per million, more preferably less than 100 parts per million. It is especially preferred that the ink has less than 100, more preferably less than 50 parts per million of divalent and trivalent metals. Parts per million as used above refers to parts by weight relative to the total weight of the ink. We have found that purifying the inks to reduce the concentration of these undesirable ions reduces nozzle blockage in ink jet printing heads, particularly in thermal ink jet printers.

Preferably the process used to make the ink includes a step to remove any particles having a particle size of more than 1 micron. This may be achieved using, for example, filtration and/or centrifugation. Preferably the pigment comprises less than 10%, more preferably less than 2% and especially less than 1% by weight of particles of size of greater than 1 micron in diameter.

Preferably, the ink contains from 0.1 to 30% by weight of pigment, more preferably from 1 to 10% by weight of pigment which has been washed by the process according to the first aspect of the present invention.

Preferably, the ink does not contain any pigment which has not been washed by a process according to the first aspect of the present invention.

The ink may contain a mixture of two or more different pigments each of which have been washed by the process according to the first aspect of the present invention.

According to another aspect of the present invention there is provided a pigment obtained or obtainable by a process according to the first aspect of the present invention.

According to a further aspect of the present invention there is provided an ink obtained or obtainable by the process of the second aspect of the present invention.

The present invention will now be illustrated by the following preferred embodiment in which all parts are by weight unless expressed to the contrary.

### EMBODIMENT

### Step 1: Water Purification

1000 parts of domestic tap or towns water may be purified by a process comprising the steps i) to v) in that order:

i) contacting the water with 100 parts of activated carbon;

ii) purifying the water by means of reverse osmosis;

iii) sterilizing the water by means of a UV lamp;

iv) storing the water in an air tight container purged with bacteria free air;

v) storing the water for no more than 24 hours prior to washing the pigment;

### Step 2: Preparation of a Pigment Dispersion

A dispersion of a pigment in water may be prepared by milling a pigment in water with the aid of a dispersant. Preferably, the milling achieves a final volume averaged pigment particles size of from 50 to 300 nm. The dispersant may be encapsulated around the pigment preferably as described in for example WO 2006/064193. Preferably, encapsulation process utilises a cross-linking reaction which is effected by heating. The heating is preferably performed by raising the temperature of the pigment dispersion to from 50 to 150° C. for a period of from 30 seconds to 24 hours. The solids content of the resulting milled dispersion may then be adjusted to about 10% by weight of pigment by the addition or removal of water as is required.

### Step 3: Washing of the Pigment

100 parts of the pigment dispersion as prepared by step 2 may then be washed using the water as provided by step 1. Preferably, this is done by cross-flow membrane filtration. As the wash water permeates from filter membrane it is preferably replaced by fresh purified water from step 1 (i.e. the washing is performed by a diafiltration method). Fresh purified water may be added until all of the 1000 parts of water obtainable by step 1 has been used. The washed pigment dispersion may then by concentrated as desired by the membrane filtration (for example providing a dispersion having a solids content of 10 to 15% by weight of pigment).

### Step 4: Storage of the Washed Pigment

The purified pigment dispersion prepared by steps 1-3 may be stored in a sealed, sterilized container purged with bacteria free air.

### Step 5: Ink Jet Ink Additives

Any ink jet printing ink additives used to prepare the final ink preferably also have very small amount of colony forming units, preferably less than 100 cfu's per ml. The preferred level of cfu's may be obtained by ultra filtration, heating and/or UV sterilisation.

Preferred ink additives are as described above i.e. viscosity modifiers, pH buffers (e.g. 1:9 citric acid/sodium citrate) corrosion inhibitors, biocides, dyes, water, organic solvent(s) and/or kogation reducing additives.

### Step 6: Addition of the Additives to the Purified Pigment Dispersion

It is preferred that the additives prepared in step 5 are mixed with the dispersion resulting from steps 1-4 in a manner that shields the mixture from airborne bacteria. Preferably this is achieved, by purging the sterilized equipment (e.g. vessels, pipes and containers) with bacteria free air.

By use of the steps 1-6 ink jet printing inks may be prepared which exhibit the hereinbefore mentioned performance advantages, particularly improved storage stability and print performance.

### Further Inks

The further inks described in Tables I and II may be prepared wherein washed pigment dispersions (WPDs) preparable by steps 1-4 (having a final solids content of 10% by weight) may be mixed with additives as defined below. Numbers quoted in the columns refer to the number of parts of the relevant ingredient and all parts are by weight. The inks may be applied to paper by thermal, piezo or Memjet ink jet printing.

The following abbreviations are used in Table I and II:

PG=propylene glycol

DEG=diethylene glycol

NMP=N-methylpyrrolidone

DMK=dimethylketone

iPA=isopropanol

MeOH=methanol

2P=2-pyrrolidone

MIBK=methylisobutyl ketone

P12=propane-1,2-diol

BDL=butane-2,3-diol

Surf=Surfynol™465 from Airproducts

PHO=Na₂HPO₄ and

TBT=tertiary butanol

TDG=thiodiglycol

WPDs=Washed pigment dispersions obtainable from steps 1-4

TABLE I

| | | | | | | | Na | | | | |
|---|---|---|---|---|---|---|---|---|---|---|---|
| WPDs | Water | PG | DEG | NMP | DMK | NaOH | Stearate | IPA | MEOH | 2P | MIBK |
| 30 | 50 | 5 | | 6 | 4 | | | | | 5 | |
| 30 | 59.8 | | 5 | 5 | | 0.2 | | | | | |
| 40 | 45 | 3 | | 3 | 3 | | | | 5 | 1 | |
| 40 | 51 | | 8 | | | | | | | | 1 |
| 40 | 45.8 | 5 | | | | | 0.2 | 4 | | | 5 |
| 40 | 41 | | | 9 | | 0.5 | 0.5 | | | 9 | |
| 40 | 10 | 4 | 15 | 3 | 3 | | | 6 | 10 | 5 | 4 |
| 40 | 30 | | 20 | | | | | 10 | | | |
| 50 | 25 | 5 | 4 | | 5 | | | | 6 | | 5 |
| 50 | 29.7 | 3 | 5 | 2 | 10 | | 0.3 | | | | |
| 50 | 15 | | 5 | 4 | 6 | | | 5 | 4 | 6 | 5 |
| 50 | 46 | | | | | | | | 4 | | |
| 40 | 50 | 5 | | | | | | 5 | | | |
| 40 | 40 | 2 | 6 | 2 | 5 | | | 1 | | 4 | |
| 40 | 40 | | 5 | | | | | | | 15 | |
| 40 | 44 | | | 11 | | | | | | 5 | |
| 50 | 30 | 2 | | | 10 | | | | 2 | | 6 |
| 50 | 39.7 | | | | 7 | 0.3 | | 3 | | | |
| 40 | 29 | 2 | 20 | 2 | 1 | | | | | 3 | 3 |
| 40 | 51 | | | 4 | | | | | | 5 | |

TABLE II

| WDC | Water | PG | DEG | NMP | Surf | TBT | TDG | BDL | PHO | 2P | PI2 |
|---|---|---|---|---|---|---|---|---|---|---|---|
| 30 | 49.8 | 15 | | | 0.2 | | | | | 5 | |
| 30 | 58.8 | | 5 | | | | | | 1.2 | | 5 |
| 40 | 44.65 | 5 | 5 | | 0.15 | 5.0 | 0.2 | | | | |
| 40 | 49.88 | | 6 | 4 | | | | | 0.12 | | |
| 40 | 41.7 | 4 | 8 | | 0.3 | | | | | | 6 |
| 40 | 44.8 | | 10 | | | | | 5 | 0.2 | | |
| 50 | 39.7 | | 5 | 5 | | | 0.3 | | | | |
| 50 | 20 | | 10 | 4 | | | | 1 | | 4 | 11 |
| 40 | 35 | 4 | 10 | 3 | | | | 2 | | 6 | |
| 40 | 51 | | | 6 | | | | | | 3 | |
| 40 | 35.05 | | 9 | 7 | | 3.0 | | | 0.95 | 5 | |
| 40 | 38 | 5 | 11 | | | | | | | 6 | |
| 50 | 36 | | | 7 | | | | | | 7 | |
| 50 | 24.5 | 5 | 5 | 4.1 | 1 | 0.2 | 0.1 | 5 | 0.1 | 5 | |
| 40 | 50 | | 10 | | | | | | | | |
| 40 | 50 | | | | | | 10 | | | | |
| 30 | 48 | | | 5 | | | 12 | | | 5 | |
| 30 | 40 | 2 | | 8 | | | 15 | | | 5 | |
| 40 | 40 | | | | | | 8 | | | 12 | |
| 40 | 50 | | 10 | | | | | | | | |

1. A process for purifying a pigment comprising washing the pigment with water having less than 100 ppm by weight of total dissolved solids and a microbiological contamination of less than 100 colony forming units per ml.

2. A process according to claim 1 wherein the water has less than 10 colony forming units per ml.

3. A process according to claim 1 wherein the water has less than 50 ppm of total dissolved solids.

4. A process according to claim 1 which further comprises the step of irradiating the water with UV light.

5. A process according to claim 1 which further comprises the step of filtering the water using a filter having an average pore size of no more than 1 micron.

6. A process according to claim 1 which further comprises the step of shielding the water from airborne bacteria.

7-8. (canceled)

9. A process according to claim 1 wherein the washing method comprises cross-flow filtration.

10. (canceled)

11. A process according to claim 1 wherein the washing is performed by a process comprising centrifugation, decantation and/or filtration.

12. A process according to claim 1 wherein the pigment is encapsulated with a cross-linked dispersant.

13. A process for preparing an ink comprising purifying a pigment by a process according to claim 1 and mixing the purified pigment with one or more ink additives.

14. A process according to claim 13 wherein said mixing is performed under conditions which shield the purified pigment and the one or more ink additives from airborne bacteria.

15. A process according to claim 13 wherein all the ink additives have a microbiological contamination of less than 100 colony forming units per ml.

16. A process according to claim 13 which further comprises the step of shielding the resultant ink from airborne bacteria.

17. A process according to claim 13 wherein the viscosity of the resultant ink is less than 50 mPa·s, when measured at a temperature of 25° C.

18. A process according to claim 13 wherein the surface tension of the resultant ink is 20 to 65 dynes/cm, when measured at a temperature of 25° C.

19-20. (canceled)
